(19) United States
(12) Patent Application Publication
(10) Pub. No.: US 2015/0355116 A1
(43) Pub. Date: Dec. 10, 2015

(54) WAVELENGTH DISPERSIVE CRYSTAL SPECTROMETER, A XRAY FLUORESCENCE DEVICE AND A METHOD THEREIN

(71) Applicant: Fenno-Aurum Oy, Espoo (FI)

(72) Inventor: Heikki Johannes SIPILA, Espoo (FI)

(21) Appl. No.: 14/734,463

(22) Filed: Jun. 9, 2015

(30) Foreign Application Priority Data
Jun. 9, 2014 (FI) 20145524

(51) Int. Cl. G01N 23/207; G01T 1/36; G21K 1/02

(52) U.S. Cl. CPC G01N 23/2076; G21K 1/02; G01T 1/36

(57) ABSTRACT

A wavelength dispersive crystal spectrometer for obtaining an energy band from an energy spectrum includes a plurality of crystal planes stacked on top of each other, wherein each of the crystal planes is made of pyrolytic graphite. Moreover, an X-ray fluorescence device including the crystal spectrometer and a method for obtaining an energy band from an energy spectrum in a X-ray fluorescence analysis are also described.

### TECHNICAL FIELD

The invention concerns in general the technical field of radiation analysis. Especially the invention concerns detection of elements within a sample by filtering an energy spectrum entering to a radiation detector.

### BACKGROUND

X-ray fluorescence (XRF) analysis is commonly used method of analyzing elements in a sample. Fundamentally the operation of X-ray fluorescence analysis is that a sample is irradiated with X-ray photons produced with an X-ray generator and the atoms within the sample get ionized. Depending on the energy of the radiation and the material within the sample one or more electrons ejects from the atom in question. The electrons may originate basically from any orbital of the atom. As one electron is ejected from a certain orbital another electron from outer orbital drops into its place. Each this kind of transition yields a fluorescent photon characteristic energy equal to the difference in energy of the initial and final orbital, which energy is measurable with a detector. This physical phenomenon enables the analysis of material, since it is possible to determine the content of the sample by analyzing the energy spectrum disclosing the characteristic energies of elements within the sample.

More specifically, the measurement of energy spectrum originating from the sample is made with applicable radiation detector, such as germanium (Ge) based detector. A challenge is that each detector is suitable for receiving only certain limited amount of radiation energy and if the received energy exceeds the limit the detector gets saturated. This is especially problematic due to the fact that XRF technique produces so called Compton scattering from the sample. The Compton scattering originates from a collision of x-ray photons with outer shell electrons of atoms in the sample. The photons scatter with a loss of energy and increased wavelength and the scattered photons end up to the detectors. As a result the Compton scattering produces non-usable energy to the detector thus driving the detector towards saturated state. The described challenge is tried to be solved by arranging multiple, like ten, detectors to measure the received radiation from the sample. This solves the challenge only partly and causes additional problems due to the fact that detectors and required electronics of those are not uniform. This, in turn, causes pressure in the analysis since there is need to mitigate such errors from the measurement.

As it comes to determining concentration of heavy metals, such as platinum, gold and uranium, within a sample the analysis is challenging due to several reasons. This is because, the concentration of the elements within a sample, such as ore, is very low, which causes high requirements for detection. That is, a utilization of so called L-line spectrometry with the heavy metals, i.e. elements with high atomic number Z, is difficult because within an energy range of heavy elements' L-lines there are several K-lines originating from elements with medium atomic number Z. Thus, an overlapping of K-lines from medium Z elements and L-lines from elements with high atomic number Z makes the analysis and detection very challenging. Moreover, K-lines originating from elements with high atomic number Z have high energy and are less overlapping with other energy lines of other type of elements.

Thus, a wavelength spectroscopy is not typically used within a detection of content of elements with high atomic number Z, because the energy resolution is worse than in energy dispersive spectrometry.

Based on above there is need to develop improved analysis system and elements thereto in order to mitigate the problems with the existing solutions. Especially, it would be advantageous to arrange such an analysis system, which provides means to bring radiation spectrum corresponding at least partly the K-lines of elements under focus to radiation detector, but at the same time reduce any undesired scattering and radiation spectrum to end up to the radiation detector.

### SUMMARY

An objective of the invention is to present a wavelength dispersive crystal spectrometer, a X-ray fluorescence device and a method for radiation analysis. Another objective of the invention is that the wavelength dispersive crystal spectrometer, the X-ray fluorescence device and the method enable filtering of an energy spectrum received from an irradiated sample so that an energy band being a subset of the energy spectrum reaches a radiation detector.

The objects of the invention are reached by a wavelength dispersive crystal spectrometer, a X-ray fluorescence device and a method as defined by the respective independent claims.

According to a first aspect, a wavelength dispersive crystal spectrometer for obtaining an energy band from an energy spectrum is provided, the crystal spectrometer comprises a plurality of crystal planes stacked on top of each other, wherein each of the crystal planes is made of pyrolytic graphite.

The pyrolytic graphite may be laid on a substrate made of heavy metal.

A scattering angle between the crystal planes for a radiation entered between the crystal planes may be less than two degrees.

A number of crystal planes within the crystal lattice may be between 4 to 12.

According to a second aspect, a X-ray fluorescence device is provided, the device comprising a X-ray radiation source for producing a radiation beam to be focused at least partly in a sample, a germanium based radiation detector for obtaining radiation from the sample in response to an irradiation of the sample with the radiation beam, and a wavelength dispersive crystal spectrometer as defined is positioned between the sample and the radiation detector.

A collimator may be arranged between the crystal lattice and the radiation detector in the X-ray fluorescence device. The collimator may be a Soller slit type with an acceptance angle less than a mocaicity angle of pyrolytic graphite.

The crystal spectrometer and the collimator may be positioned with respect to each other so that non-reflected radiation passing through the crystal spectrometer is configured to be absorbed in the aperture of the collimator.

According to a third aspect, a method for obtaining an energy band from an energy spectrum in a X-ray fluorescence analysis is provided, the method comprises positioning a wavelength dispersive crystal spectrometer as defined between the sample and a radiation detector of a X-ray fluorescence device.

The exemplary embodiments of the invention presented in this patent application are not to be interpreted to pose limitations to the applicability of the appended claims. The verb “to comprise” is used in this patent application as an open limitation that does not exclude the existence of also un-recited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

The embodiments of the invention are illustrated by way of example, and not by way of limitation, in the figures of the accompanying drawings.

FIG. 1 illustrates schematically an example of a wavelength dispersive crystal spectrometer according to the invention.

FIG. 2 illustrates schematically an example of a crystal plane within the crystal spectrometer according to the invention.

FIG. 3 illustrates schematically an operation of the crystal spectrometer according to the invention.

FIG. 4 illustrates schematically an example of a X-ray fluorescence device according to the invention.

FIG. 5 illustrates schematically positioning of certain elements of the X-ray fluorescence device according to the invention.

### DETAILED DESCRIPTION

The present invention relates to a wavelength dispersive crystal spectrometer by means of which it is possible to control an amount of incident radiation originating from a sample when irradiated entering to a radiation detector.

More specifically, a purpose of the wavelength dispersive crystal spectrometer according to the invention is to attenuate undesired scattering, such as Compton scattering, from e.g. the sample and to enable entering of desired frequency spectrum to the radiation detector. Additionally, the present invention relates to a X-ray fluorescence device wherein a wavelength dispersive crystal spectrometer is applied to. The radiation used in the application area of the invention is so called hard radiation having energy within a range between 50 keV and 160 keV.

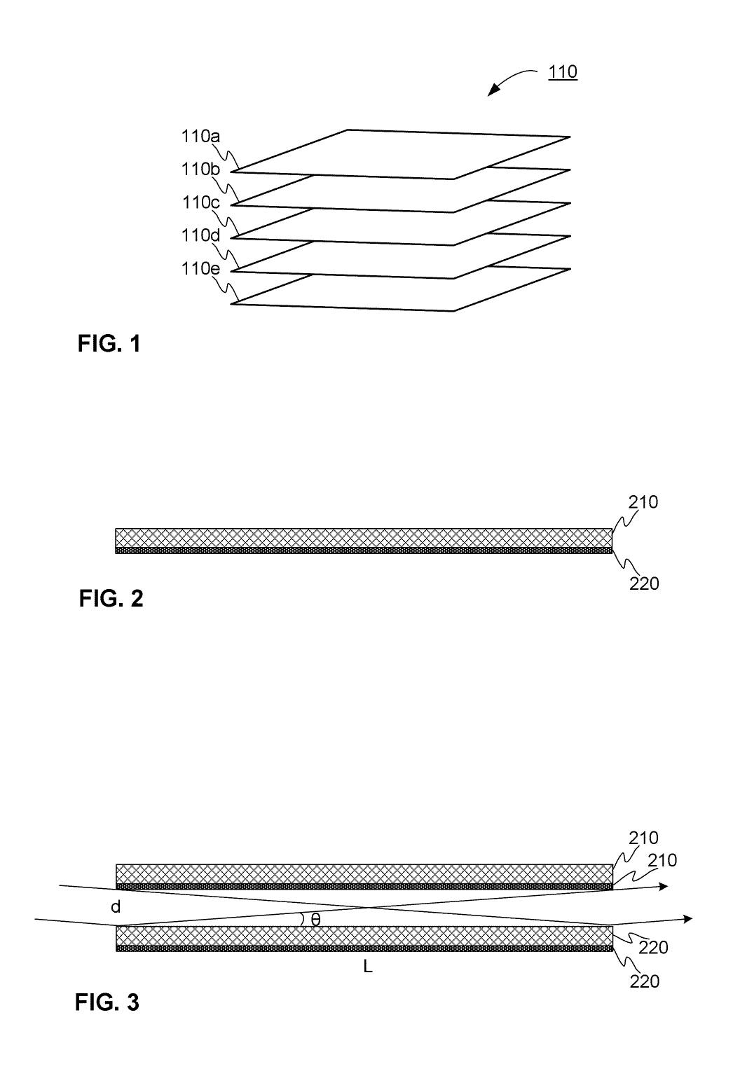

FIG. 1 illustrates schematically an example of the wavelength dispersive crystal spectrometer 110 according to the invention. The wavelength dispersive crystal spectrometer 110 comprises a plurality of crystal planes 110a-110e made of pyrolytic graphite. The number of crystal planes 110a-110e in the example of FIG. 1 is five. However, the number of crystal planes may vary between four (4) and twelve (12) in order to achieve the inventive results as described herein. The crystal planes may be rectangular in shape.

FIG. 2 discloses schematically a more detailed illustration on a crystal plane of the crystal spectrometer 110. The crystal plane within the crystal spectrometer 110 comprises a layer of pyrolytic graphite 210 and a layer of heavy metal 220, such as hafnium (Hf) or tungsten (W), as a substrate for the pyrolytic graphite 210. The pyrolytic graphite is advantageous within the application area of radiation analysis with hard radiation due to its mosaic structure, wherein mosaic spreads are an order of 0.1-0.4 degrees. The substrate layer shall be made of heavy metal since it absorbs effectively hard radiation travelling through the pyrolytic graphite and thus prevents it to enter into other levels within the crystal spectrometer.

The fundamental idea in bringing the crystal spectrometer according to the present invention into an application area of material analysis is that by means of the crystal spectrometer it is possible to obtain an energy band from an energy spectrum received by irradiating a sample with hard radiation. Especially, the present invention is applicable in analysis, wherein the aim is to determine if a sample contains gold (Au), platinum (Pt) or uranium (U), and a concentration of the elements within the sample. Namely, in order to determine the mentioned elements a hard radiation shall be used. The utilization of crystal spectrometer according to the invention for filtering is based on a fact that incident radiation from the sample entering the crystal spectrometer scatters within the crystal spectrometer. The scattering angle is defined by Bragg's law

nλ=2d sin θ,

where n is an integer, λ is the wavelength of incident wave, d is the spacing between the planes in the atomic lattice, and θ is the angle between the incident ray and the scattering planes.

According to the invention an object of the invention is to determine if a sample contains gold, platinum or uranium through an analysis of K_{α1} lines within an energy spectrum. As energies corresponding to K_{α1} lines of the mentioned elements are known, it is possible to determine wavelengths corresponding to the K_{α1} lines of the mentioned elements. And finally, by using Bragg's law for determining the θ for the mentioned elements one can receive the following results:

θ_{Pt}=1,585 °

θ_{Au}=1,539 °

θ_{U}=1,076 °.

Thus, the crystal planes within crystal spectrometer structure shall be dimensioned and positioned so that the structure enables scattering of radiation below two degrees so that the desired energy spectrum may enter a radiation detector within the analysis system. FIG. 3 illustrates, as an example, that a distance between the crystal planes is d and the length is L, and how the radiation is reflected between the crystal planes. A practical length of the crystal plane is 50 mm, which results that the distance d between the planes shall be 1.34 mm in an analysis of gold in order to enable a travel of scattered radiation originating from an irradiation of gold within the sample with hard radiation through the crystal spectrometer. Naturally, the distance varies with respect to material, i.e. element, under focus. FIG. 3 discloses the scattering angle θ, which determines the maximum angle the incoming radiation may scattering within the crystal spectrometer. In context of analyzing heavy materials within the sample the size of the crystal spectrometer remains small due to the small scattering angle. Thus, stacking of e.g. 10 crystal planes according to the present invention produces a crystal spectrometer with a thickness of 20 mm.

The mentioned lengths of the crystal planes and distance between the planes are only examples and vary on the grounds, which element is under focus in the analysis.

As already mentioned the crystal planes 110a-110e within the wavelength dispersive crystal spectrometer are made of pyrolytic graphite. Pyrolytic graphite is especially advantageous for the purpose as described due to the fact that its reflection intensity for so called hard radiation is much better than a reflection intensity of typically used crystal spectrometers, such as quartz or LiF.

FIG. 1 does not disclose for clarity reasons, how the crystal planes are coupled within the wavelength dispersive crystal spectrometer structure. For example, the wavelength dispersive crystal spectrometer structure may be formed so that the crystal planes are mounted e.g. by gluing into a support structure providing support e.g. in every corner of the spectrometer. In such a manner established structure may then be positioned in a frame, which may further be fixed into a X-ray fluorescence device, for example. The frame may provide space to mount some other elements of the X-ray fluorescence device, as will be discussed later.

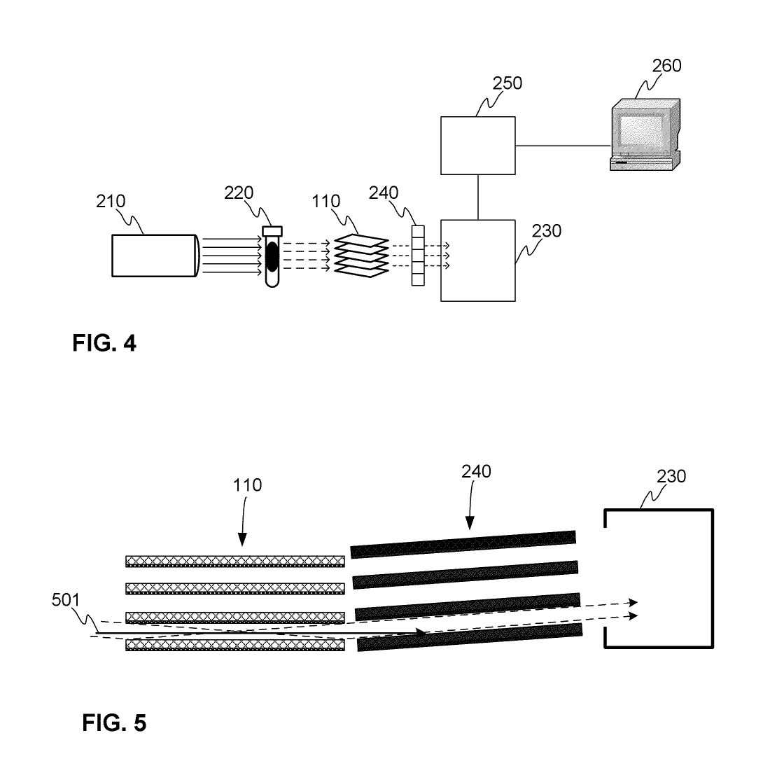

FIG. 4 illustrates schematically a X-ray fluorescence device comprising the wavelength dispersive crystal spectrometer as described. The X-ray fluorescence device comprises at least a X-ray radiation source 210 for producing a radiation beam to be focused at least partly in a sample 220. Further, the X-ray fluorescence device comprises a germanium based radiation detector 230 for obtaining radiation from the sample in response to an irradiation of the sample with the radiation beam of the radiation source 210. According to the present invention a wavelength dispersive crystal spectrometer as described above is positioned between the sample and the radiation detector for attenuating undesired scattering, such as Compton scattering, from the sample due to irradiation and to enable entering of desired frequency spectrum to the radiation detector. In case of analyzing a concentration of heavy elements within a sample the desired frequency spectrum is optimally such that energy spectrum comprising K-lines originating from heavy elements when irradiated end up to the radiation detector 230, while at the same time other frequency spectrum and scattering does not reach the radiation detector.

Furthermore, a collimator 240, such as a Soller slit type collimator, may be arranged between the wavelength dispersive crystal spectrometer and the radiation detector. The Soller slit type collimator is such that its acceptance angle is, at least preferably, less than a mocaicity angle of pyrolytic graphite used in the wavelength dispersive crystal spectrometer 110. The Soller slit type collimator prevents any direct radiation from the sample to reach the detector 230. In other words, aim is to minimize the direct radiation from the sample and maximize the reflected radiation within the crystal spectrometer ending up to the radiation detector 230 by mounting the crystal spectrometer and the collimator, in relation to each other, optimally. The Soller slit type collimator is advantageously as long as the crystal spectrometer and the distance between planes in the collimator is between 0.1-0.4 mm in order to gain the desired effect.

FIG. 4 also discloses, for the sake of clarity that the analysis system comprise signal processing electronics 250 for pre-processing the data obtained from the detector 230 and computing unit 260 for processing the data as well as controlling the system as a whole.

FIG. 5 schematically illustrates the crystal spectrometer 110 according to the present invention as well as Soller slit type collimator 240 and the radiation detector 230. FIG. 5 discloses how the crystal spectrometer 110 and the Soller slit type collimator shall be mounted in relation to each other for preventing the direct radiation 501 ending up to radiation detector 230. Only the reflected radiation reaches the detector 230. In other words, the crystal spectrometer and the collimator are positioned with respect to each other so that non-reflected radiation passing through the crystal spectrometer absorbs in the aperture of the collimator. The term ‘aperture’ refers to an opening, or channel, between the planes within the collimator. It is worthwhile to mention that also the hard radiation produces an amount of Compton scattering origination from the crystal spectrometer itself. The Soller slit type collimator also prevents at least partially that the Compton scattering reaches the detector thus improving the accuracy of the analysis solution according to the invention. As already mentioned the crystal spectrometer 110 and the collimator may be mounted into a frame providing optimal positions of the mentioned elements with respect to each in order to prevent, at least partially, entering of the direct radiation from the sample to the detector 230.

The solution according to present invention as a whole provides a solution for filtering undesired part(s) from an energy spectrum and thus only the interesting part of the energy spectrum reaches the detector 230. The crystal spectrometer according to the present invention enables that radiation with sufficient intensity may reach the detector and thus enables the analysis of elements under focus, and especially the K-lines of those. The invention is above described by disclosing examples in the context of certain elements, but the invention may also be applied with other elements as long as the desired effect may be achieved.

Some advantageous embodiments according to the invention were described above. The invention is not limited to the embodiments described. The inventive idea can be applied in numerous ways within the scope defined by the claims attached hereto.

1. A wavelength dispersive crystal spectrometer for obtaining an energy band from an energy spectrum, comprising a plurality of crystal planes stacked on top of each other, wherein each of the crystal planes is made of pyrolytic graphite.

2. A wavelength dispersive crystal spectrometer according to claim 1, wherein the pyrolytic graphite is laid on a substrate made of heavy metal.

3. The wavelength dispersive crystal spectrometer according to claim 1, wherein a scattering angle between the crystal planes for a radiation entered between the crystal planes is less than two degrees.

4. The wavelength dispersive crystal spectrometer according to claim 1, wherein a number of crystal planes within the crystal lattice is between 4 to 12.

5. A X-ray fluorescence device comprising
a X-ray radiation source for producing a radiation beam to be focused at least partly in a sample,
a germanium based radiation detector for obtaining radiation from the sample in response to an irradiation of the sample with the radiation beam,
a wavelength dispersive crystal spectrometer according to claim 1 is positioned between the sample and the radiation detector.

6. The X-ray fluorescence device according to claim 5, wherein a collimator is arranged between the crystal lattice and the radiation detector.

7. The X-ray fluorescence device according to claim 6, wherein the collimator is a Soller slit type with an acceptance angle less than a mocaicity angle of pyrolytic graphite.

8. The X-ray fluorescence device according to claim 6, wherein the crystal spectrometer and the collimator are positioned with respect to each other so that non-reflected radiation passing through the crystal spectrometer is configured to be absorbed in the aperture of the collimator.

9. A method for obtaining an energy band from an energy spectrum in a X-ray fluorescence analysis comprising
positioning a wavelength dispersive crystal spectrometer according to claim 1 between the sample and a radiation detector of a X-ray fluorescence device.
